(19) United States
(12) Patent Application Publication
(10) Pub. No.: US 2026/0128914 A1
(43) Pub. Date: May 7, 2026

(54) Data Processing Performance Optimization Under Power Budgeting Constraints

(71) Applicant: MELLANOX TECHNOLOGIES, LTD., Yokneam (IL)

(72) Inventors: Haim Kupershmidt, Or Yehuda (IL); Yochai Cohen, Kfar Menachem (IL); Itay Kuperstein, Haifa (IL); Krishna Sitaraman, Campbell, CA (US); Ehud Maor, Tel Aviv (IL); Rony Kositsky, Tel Aviv (IL)

(21) Appl. No.: 18/935,698

(22) Filed: Nov. 4, 2024

(51) Int. Cl. H04L 12/10; G06F 1/324; G06F 1/3296

(52) U.S. Cl. CPC H04L 12/10; G06F 1/324; G06F 1/3296

(57) ABSTRACT

A packet processing and communication system includes multiple subsystems and a power management controller. The multiple subsystems are to process and communicate packets. The power management controller is to obtain one or more performance degradation metrics, which indicate degradations in performance of the subsystems in processing the packets, to evaluate a cost function defined over the performance degradation metrics, and to allocate respective electrical power quotas to the subsystems, aiming to minimize the cost function.

### TECHNICAL FIELD

The present disclosure relates generally to packet processing and communication systems, and particularly to methods and systems for optimizing packet-processing performance under power budgeting constraints.

### BACKGROUND

Electronic systems are often constrained with respect to the maximal amount of electrical power they are permitted to consume. The overall power consumption of a system may be constrained due to, for example, limitations of the power supply subsystem or to thermal constraints. Power constraints can be enforced, for example, by limiting current consumption, or by reducing operation voltage and/or clock speed.

### SUMMARY

An embodiment that is described herein provides a packet processing and communication system including multiple subsystems and a power management controller. The multiple subsystems are to process and communicate packets. The power management controller is to obtain one or more performance degradation metrics, which indicate degradations in performance of the subsystems in processing the packets, to evaluate a cost function defined over the performance degradation metrics, and to allocate respective electrical power quotas to the subsystems, aiming to minimize the cost function.

In some embodiments, the system further includes one or more Power Management (PM) circuits to limit power consumption of at least one of the subsystems, and the power management controller is to allocate the electrical power quotas by controlling the PM circuits. In an example embodiment, at least one of the PM circuits includes a current limiter circuit to limit input current to a corresponding subsystem. In a disclosed embodiment, at least one of the PM circuits includes a voltage/frequency control circuit to set one or both of (i) an operating voltage and (ii) a clock speed, of a corresponding subsystem.

In an embodiment, at least one of the performance degradation metrics is indicative of a rate of packet dropping by one or more of the subsystems. In another embodiment, at least one of the performance degradation metrics is indicative of a number of pending packets in one or more of the subsystems. In yet another embodiment, at least one of the performance degradation metrics is indicative of a latency in processing the packets in one or more of the subsystems. In still another embodiment, at least one of the performance degradation metrics is indicative of an extent of backpressure, which throttles reception of packets in one or more of the subsystems from one or more other subsystems. In an embodiment, at least one of the performance degradation metrics is indicative of an extent of flow control, which throttles transmission of packets from one or more of the subsystems to one or more other subsystems.

Typically, the power management controller is to run an iterative process that obtains updated values of the performance degradation, re-evaluates the cost function over the updated values, and reallocates the electrical power quotas based on the re-evaluated cost function. In some embodiments, the power management controller is to enforce the allocated electrical power quotas on the subsystems only when the communication system as a whole exceeds a specified power consumption.

In an embodiment, the power management controller is to modify the cost function in response to a hint indicative of a pattern of packet processing or communication in the system. In another embodiment, the power management controller is to modify the cost function in response to a hint indicative of a type of application running in the system. In yet another embodiment, the power management controller is to modify the cost function in response to a hint indicative of a ratio between east-west traffic and north-south traffic in the system. In some embodiments, the power management controller is to evaluate the cost function by calculating a weighted sum of two or more of the performance degradation metrics.

There is additionally provided, in accordance with an embodiment that is described herein, a power management method including processing and communicating packets by multiple subsystems of a system. One or more performance degradation metrics, which indicate degradations in performance of the subsystems in processing the packets, are obtained. A cost function, defined over the performance degradation metrics, is evaluated. Respective electrical power quotas are allocated to the subsystems, aiming to minimize the cost function.

There is also provided, in accordance with an embodiment that is described herein, a power management controller including an interface and a processor. The interface is to operationally couple to multiple subsystems that process and communicate packets. The processor is to obtain one or more performance degradation metrics, which indicate degradations in performance of the subsystems in processing the packets, to evaluate a cost function defined over the performance degradation metrics, and to allocate respective electrical power quotas to the subsystems, aiming to minimize the cost function.

There is further provided, in accordance with an embodiment that is described herein, a power management controller including an interface and a processor. The interface is to operationally couple to multiple subsystems that process data. The processor is to obtain one or more performance degradation metrics, which indicate degradations in performance of the subsystems in processing the data, to evaluate a cost function defined over the performance degradation metrics, and to allocate respective electrical power quotas to the subsystems, aiming to minimize the cost function.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a packet processing and communication system, in accordance with an embodiment that is described herein;

FIG. 2 is a flow chart that schematically illustrates a method for allocation of electrical power quotas based on packet processing performance, in accordance with an embodiment that is described herein; and

FIG. 3 is a block diagram that schematically illustrates a computing system that employs allocation of electrical power quotas based on packet processing performance, in accordance with an embodiment that is described herein.

### DETAILED DESCRIPTION OF EMBODIMENTS

### Overview

Packet processing and communication systems, such as data centers or High-Performance Computing (HPC) systems, may comprise multiple subsystems that perform various computational and packet-processing tasks and communicate with one another.

Consider, for example, a cluster of compute nodes that execute Artificial Intelligence (AI) jobs. Each compute node may comprise one of more Graphics Processing Units (GPUs), one or more Central Processing Unit (CPU), one or more Data Processing Unit (DPU and/or one or more network adapters. A compute node may include one or more switches or NVswitches. The compute nodes communicate with one another, using their network adapters, over a packet network. The compute nodes are also referred to herein as “GPU nodes”.

In an example system configuration, a given compute node is required not to exceed a specified maximal power consumption budget. There are, however, numerous ways of limiting the power consumptions of individual subsystems of the compute node (e.g., individual GPUs, CPUs, DPUs, switches and/or network adapters, or even individual GPU cores and/or CPU cores) while still meeting the maximal budget.

The choice of how to divide the power consumption budget among the different subsystems can have a considerable impact on the performance of the compute node. Moreover, the optimal division of the power budget may change over time, e.g., depending on workload. For example, cutting down the power consumption of a heavily loaded GPU would degrade the system performance considerably, as opposed to limiting the power consumption of a relatively idle GPU. Similarly, it may be highly undesirable to reduce the power consumption of a network adapter that is currently a communication bottleneck of the compute node.

Embodiments that are described herein provide improved techniques for allocating electrical power to subsystems of a packet processing and communication system. The disclosed techniques allocate electrical power quotas to respective subsystems, aiming to optimize the packet-processing performance of the system within the available power budget.

In some embodiments, the system comprises a power management controller (referred to below simply as “controller” for brevity) that is responsible for dividing the available power budget among the subsystems. The controller monitors the performance of the subsystems to obtain “performance degradation metrics”. In the present context, the term “performance degradation metric” refers to any quantitative measure of the packet processing performance of a subsystem that is adversely affected by power-consumption limiting.

For a given subsystem (e.g., a CPU, GPU, DPU, network adapter, switch, NVswitch or individual core of a CPU or GPU), non-limiting examples of performance degradation metrics include the following:
An increase in packet dropping rate in the subsystem.
An increase in the number of packets that are pending (e.g., queued or buffered) in the subsystem.
An increase in average and/or maximal packet-processing latency in the subsystem.
An increase in the extent of backpressure applied to a preceding subsystem (which sends packets to the given subsystem for processing).
An increase in the extent of flow-control applied by a subsequent subsystem (which receives packets from the given subsystem for processing).

In an embodiment, the controller evaluates a cost function that is defined over the performance degradation metrics obtained from the various subsystems. The cost function may comprise, for example, a weighted sum of two or more of the performance degradation metrics. The controller allocates respective electrical power quotas to the subsystems, up to the maximal power consumption budget, aiming to minimize the cost function. Typically, the controller runs an iterative process that periodically updates the performance degradation metrics, re-evaluates the cost function, and re-allocates the electrical power quotas to the subsystems.

By minimizing the cost function, the disclosed techniques can optimize the performance of a packet processing and communication system within a specified power budget. The disclosed techniques are particularly effective in large and complex systems in which the relationship between performance and power consumption is complex, time-varying and differs from one subsystem to another.

### System Description

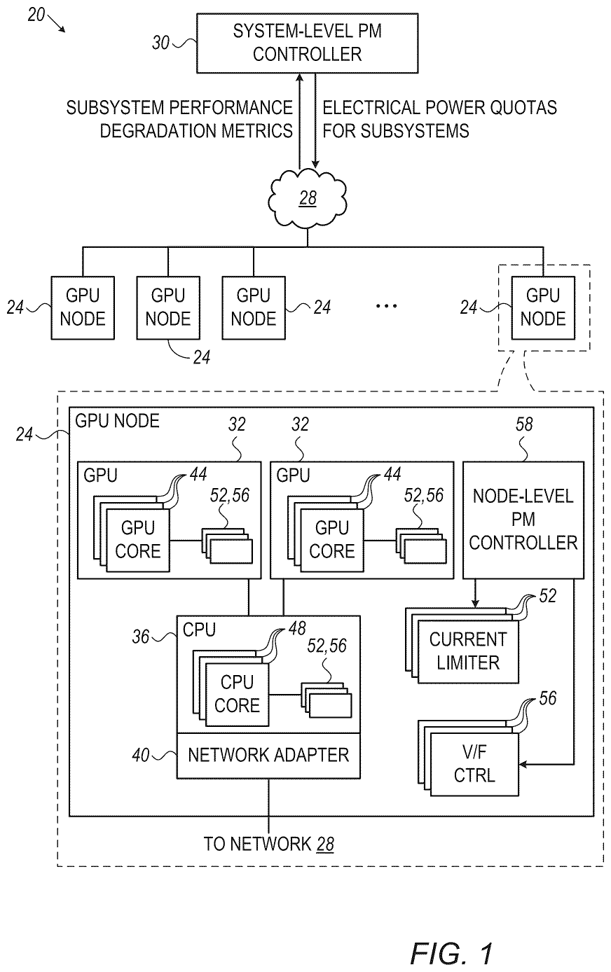

FIG. 1 is a block diagram that schematically illustrates a packet processing and communication system 20, in accordance with an embodiment that is described herein. In the present example, system 20 is incorporated in a data center designed to perform High-Performance Computing (HPC) tasks such as Artificial Intelligence (AI) tasks. Generally, however, the disclosed techniques can be used with any other suitable system involving processing and communication of packets.

In the embodiment of FIG. 1, system 20 comprises a plurality of GPU nodes 24 that communicate with one another over a network 28. Network 28 may comprise, for example, an InfiniBand™ (IB) or Ethernet network. System 20 further comprises a system-level Power Management (PM) controller 30 connected to network 28. Controller 30 is responsible, possibly among other tasks, for allocating quotas of electrical power to GPU nodes 24.

An inset at the bottom of FIG. 1 illustrates the internal structure of one of GPU nodes 24, in an embodiment. The other GPU nodes typically have a similar structure. GPU node 24 comprises one or more GPUs 32 (in the present example two GPUs), a CPU 36 and a network adapter 40. Network adapter 40 may comprise, for example, an InfiniBand Host Channel Adapter (HCA) or an Ethernet Network Interface Controller (NIC). In some embodiments, CPU 36 and network adapter 40 are integrated together in a single platform referred to as a “smart NIC” or Data Processing Unit (DPU). Each GPU 32 comprises multiple processing cores referred to as GPU cores 44. CPU 36 comprises multiple processing cores referred to as CPU cores 48.

GPU node 24 further comprises a node-level Power Management (PM) controller 58, which is responsible for allocating quotas of electrical power to the various subsystems of the GPU node, e.g., to individual GPUs 32 and to CPU 36. Thus, system-level PM controller 30 and the multiple node-level PM controllers 58 operate in a hierarchical manner. Controller 30 manages power allocation at the granularity of entire GPU nodes 24 within system 20. Controllers 58 manage power allocation at the finer granularity of GPUs, CPUs and network adapters (and in some embodiments at an even finer granularity of CPU/GPU cores) within GPU nodes 24.

In some embodiments, GPU node 24 comprises Power Management (PM) circuits that are controlled by node-level PM controller 58. The PM circuits limit the power consumptions of individual subsystems of the GPU node according to the appropriate power quotas. The PM circuits may comprise, for example, one or more current limiters 52 (also referred to as Input Current Limiters—ICLs) and/or one or more Voltage/Frequency (V/F) control circuits 56.

A given ICL 52 limits power consumption by capping the maximal current that can be drawn by the respective subsystem. A given V/F control circuit 56 limits power consumption by setting the operating voltage and/or clock speed (clock frequency) of the respective subsystem. A V/F control circuit 56 may, for example, control the operating voltage by controlling a Low-Dropout (LDO) regulator that powers the subsystem. A V/F control circuit 56 may, for example, control the clock speed by controlling a clock source, e.g., a Frequency-Locked Loop (FLL), that generates a clock signal for the subsystem. Alternatively, other suitable types of PM circuits can also be used. ICLs 52 and V/F control circuits 56 are controlled by node-level PM controller 58.

In some implementations, a given PM circuit (e.g., ICL or V/F control circuit) is used for multiple purposes, for example:
Enforcing the power quota allocated to the corresponding subsystem, as part of the disclosed power budgeting techniques.
Power capping, i.e., ensuring that the corresponding subsystem does not exceed a maximal power consumption defined for the subsystem.
Responding to thermal events.

Each PM circuit (ICL 52 or V/F control circuit 56) is coupled to limit the power consumption of a respective subsystem. In various implementations, the partitioning of GPU node 24 into subsystems may be performed with various levels of (i) granularity and (ii) hierarchy.

In one implementation, power management is applied to each GPU 32 as a whole, to CPU 36 as a whole, and to network adapter 40. In other words, GPUs 32, CPU 36 and network adapter 40 are regarded as the subsystems of GPU node 24. In this implementation, each GPU is coupled to a respective PM circuit (52 or 56), and so are the CPU and the network adapter. This is visualized in the figure using ICLs 52 and V/F control circuits 56 drawn outside of GPUs 32 and CPU 36.

In another implementation, power management is applied separately to each individual GPU core 44 (instead of or in addition to applying power management to the entire GPU 32), and to each individual CPU core 48 (instead of or in addition to applying power management to the entire CPU 36). Power management can similarly be applied to sub-components of network adapter 40. In such embodiments, individual GPU cores 44 and individual CPU cores 48 are regarded as subsystems of GPU node 24. In this implementation, each GPU core 44 and each CPU core 48 is coupled to a respective PM circuit (52 or 56). This is visualized in the figure using ICLs 52 and V/F control circuits 56 drawn as part of GPUs 32 and CPU 36. In some embodiments, a given PM circuit (52 or 56) may control two or more cores (44 or 48) jointly.

Hybrid implementations can also be used. For example, a PM circuit (52 or 56) can be coupled to limit the power consumption of a certain GPU 32, and, in addition, multiple PM circuits (52 or 56) can be coupled to limit the power consumption of the individual GPU cores 44 of the same GPU 32. A similar hierarchy can be defined for CPU 36 and CPU cores 48.

In some embodiments, all the PM circuits in GPU node 24 (e.g., ICLs 52 and V/F control circuits 56) are controlled by node-level PM controller 58 (including both the PM circuits that control entire GPUs/CPU and the PM circuits that control individual GPU/CPU cores). In other embodiment, each GPU 32 and CPU 36 comprises a respective lower-level PM controller (not seen in the figure) that controls power management within that GPU/CPU.

In some embodiments, the power limitations on the subsystems of a certain GPU node 24 will be activated (enforced) only if the overall power consumption of that GPU node 24 exceeds a specified power budget. To this end, system 20 may comprise additional PM circuits (e.g., ICLs) that measure and control the power on entire GPU nodes 24. This mechanism is typically carried out by system-level PM controller 30.

The configuration of system 20 and GPU node 24, as depicted in FIG. 1, are example configurations that are chosen purely for the sake of conceptual clarity. Any other suitable configurations can be used in alternative embodiments. For example, GPU nodes 24 in system 20 may differ from one another in the number of GPUs 32. System-level PM controller 30, and each node-level PM controller 58, typically comprises an interface and a processor. The interface connects to the appropriate subsystems, and the processor carries out the disclosed techniques, e.g., (i) obtains one or more performance degradation metrics, which indicate degradations in performance of the subsystems in processing the packets, (ii) evaluates a cost function defined over the performance degradation metrics, and (iii) allocates respective electrical power quotas to the subsystems, aiming to minimize the cost function.

As another example, GPU node 24 may comprise other types of subsystems that can be allocated power quotas using the disclosed techniques, e.g., various hardware accelerators. As yet another example, external or remote devices, such as external memories (e.g., a Double Data Rate Dynamic Random-Access Memory—DDR DRAM) or storage devices (e.g., a Solid-State Drive—SSD) can be considered subsystems.

As yet another example, in addition to carrying out the disclosed techniques, PM controllers 30 and 58 (and the PM circuits they control) can also be used for down-throttling power in response to thermal events.

In various embodiments, GPU nodes 24 and their components may be implemented using suitable software, using suitable hardware such as one or more Application-Specific Integrated Circuits (ASIC) or Field-Programmable Gate Arrays (FPGA), or using a combination of hardware and software. GPUs 32 and CPU 36 may comprise general-purpose processors, which are programmed in software to carry out the techniques described herein. The software may be downloaded to the processors in electronic form, over a network, for example, or it may, alternatively or additionally, be provided and/or stored on non-transitory tangible media, such as magnetic, optical, or electronic memory.

### Power Allocation Based on Packet Processing Performance

In some embodiments, node-level PM controller 58 of a given GPU node 24 carries out a continual, iterative process of allocating electrical power quotas to the various subsystems of that GPU node 24. As will be explained below, the process aims to optimize the packet processing performance of the GPU node, while ensuring that the total power consumption of the subsystems does not exceed the maximal power budget defined for the GPU node.

In an example embodiment, node-level PM controller 58 obtains the following information from GPU node 24 in each iteration of the process:
The actual total power consumption of the GPU node.
Actual power consumptions of subsystems. This information can be obtained, for example, from the various voltage regulators that supply power to the subsystems.
Performance degradation metrics of at least some of the subsystems—Elaborated and demonstrated below.
Additional system-level hints, e.g., hints indicative of a time-varying utilization pattern of one or more of the subsystems (e.g., whether the GPU node is now executing an inference phase or a traffic phase of an AI task), or indicative of the type of application running in the GPU node.
Any additional relevant information.

Controller 58 uses the collected information to calculate power quotas for the subsystems of GPU node 24 (e.g., to GPUs 32, CPU 36 and network adapter 40, and possibly with a finer granularity to individual GPU cores 44 and CPU cores 48, as well as sub-components of network adapter 40, and/or external devices such as DRAM/SSD).

In particular, controller 58 calculates the power quotas based on performance degradation metrics obtained from the subsystems. The performance degradation metrics may comprise, for example:
An increase in packet dropping rate in a subsystem.
An increase in the number of packets that are pending (e.g., queued or buffered) in a subsystem.
An increase in average and/or maximal packet-processing latency in a subsystem.
An increase in the extent of backpressure (e.g., decrease in the number of credits) applied to a preceding subsystem that sends packets to the given subsystem for processing. Backpressure is used for throttling reception of packets from the preceding subsystem, and therefore a larger extent of backpressure is indicative of degraded packet-processing performance.
An increase in the extent of flow-control applied in the subsystem, due to backpressure from a subsequent subsystem that receives packets from the given subsystem for processing. Flow-control is used for throttling transmission of packets to the subsequent subsystem, and therefore a larger extent of flow-control is indicative of degraded packet-processing performance.
Any other suitable metric.

In a given iteration of the process, controller 58 evaluates a cost function that is defined over at least some of the performance degradation metrics. In an example embodiment, the cost function comprises a weighted sum of at least some of the performance degradation metrics:

$$Cost = {\sum }_{i = 1}^{N} [ \text{} {K}_{1 i} \cdot DroppedPacket s ( i ) + {K}_{2 i} \cdot PendingPacket s ( i ) + {K}_{3 i} \cdot AvgLatency ( i ) + {K}_{4 i} \cdot MaxLatenc y ( i ) + {K}_{5 i} \cdot Backpressure ( i ) + {K}_{6 i} \cdot FlowContro l ( i ) ]$$

wherein i is an index of the subsystem being considered, and K₁ᵢ, K₂ᵢ . . . K₆ᵢ are coefficients (weights) indicative of the relative significance of the various types of performance degradation metrics in the cost function. The relative significance, and therefore the set of coefficients, may differ from one subsystem to another.

The cost function given above is an example that is chosen purely for the sake of conceptual clarity. In alternative embodiments, any other suitable cost function can be used. For example, one or more of the performance degradation metrics (e.g., PendingPackets, DroppedPackets and/or MaxLatency) can be used as constraints that must not be exceeded (similarly to the total power budget) instead of or in addition to serving as elements of the cost function.

Controller 58 calculates the power quotas for the various subsystems, aiming to minimize the cost function while keeping the total power consumption of the GPU node below the maximal power budget. Any suitable optimization scheme can be used, e.g., various trial-and-error or gradient-based schemes.

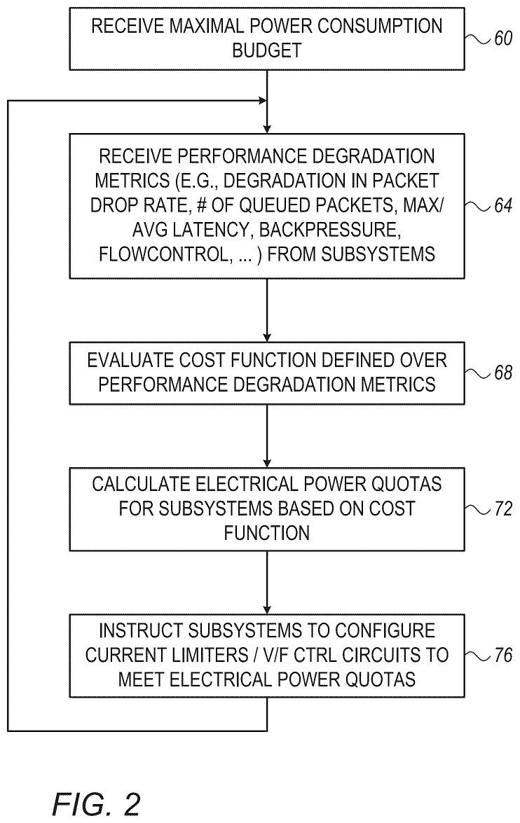

FIG. 2 is a flow chart that schematically illustrates a method for optimizing the packet-processing performance of GPU node 24 under power budget constraints, in accordance with an embodiment that is described herein. The method begins with node-level PM controller 58 receiving a maximal power consumption budget for the GPU node, at a configuration stage 60.

At a metrics input stage 64, controller 58 obtains performance degradation metrics from the subsystems of the GPU node. At a cost function evaluation stage 68, controller 58 evaluates the cost function using the obtained values of the performance degradation metrics. At a quota calculation stage 72, controller 58 calculates the power quotas for the various subsystems based on the cost function. At a quota setting stage 76, controller 58 controls the PM circuits (e.g., ICLs 52 and V/F control circuits 56) to limit the power consumptions of the subsystems in accordance with the respective quotas.

The method then loops back to stage 64 above, for performing the next iteration of the process (i.e., for obtaining updated values of the performance degradation metrics, re-evaluating the cost function, and re-calculating and setting the power quotas).

### ADDITIONAL EMBODIMENTS AND VARIATIONS

In some embodiments, controller 58 modifies the cost function (e.g., the weight coefficients K₁ᵢ, K₂ᵢ . . . K₆ᵢ in the example above, or the function in general) in response to a system-level hint that is indicative of the operation regime of the GPU node. For example, controller 58 may receive a hint indicating the specific type of application running on the GPU node, and modify the cost function to match this application. As another example, when the GPU node runs an AI task, controller 58 may modify the cost function depending on whether the GPU node currently runs an inference phase or a traffic phase of the AI task. As yet another example, controller 58 may modify the cost function depending on a hint indicative of the ratio between the amount of “east-west” traffic (traffic within the system) and “north-south” traffic (traffic into and out of the system, e.g., to users or controllers of the system).

The embodiments described herein refer mainly to a GPU node 24 as the system (for which the maximal power budget is defined, and whose subsystems are assigned power quotas using the disclosed techniques). In alternative embodiments, the disclosed power budgeting techniques can be used with any other suitable system, e.g., a cluster of GPU nodes (e.g., system 20), an individual GPU or CPU, or any other suitable system. For a given system, any suitable partitioning into subsystems can be used.

### Example System Use-Case

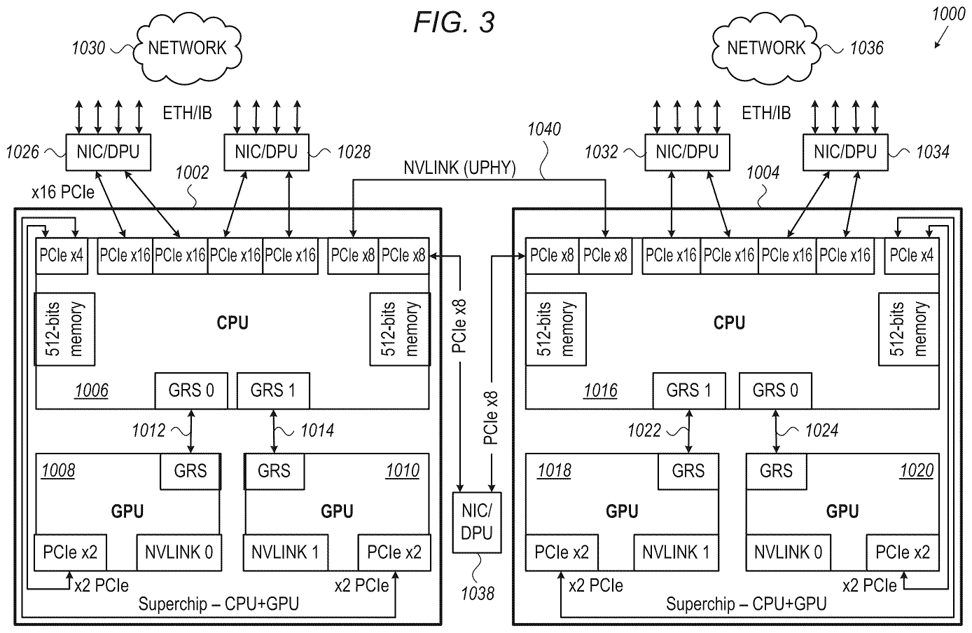

FIG. 3 is a block diagram that schematically illustrates a computing system 1000, e.g., a data center or a High-Performance Computing (HPC) cluster, in accordance with an embodiment that is described herein. System 1000 comprises a plurality of subsystems, e.g. multiple processing devices coupled to each other, multiple network devices, and multiple networks, according to at least one embodiment. Computing system 1000 is designed with multiple integrated circuits (referred to as processing devices), where each integrated circuit can include one or more CPUs and GPUs, forming a powerful and flexible architecture.

The various processing devices are interconnected via an NVLink or other high-speed interconnect, enabling high-speed communication between the subsystems, and are also connected through a NIC or DPU to ensure efficient data transfer across computing system 1000 and to one or more external networks 1030, 1036.

The coupling of processing devices through NVLink allows for seamless data exchange and parallel processing, enhancing overall computational performance. The processing devices are connected to multiple networks through one or more NICs or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs.

FIG. 3 also demonstrates an example architecture of a multi-GPU architecture. As illustrated in the figure, computing system 1000 includes a processing device 1002 with a multi-GPU architecture. In particular, processing device 1002 may be a system-on-chip and includes multiple subsystems such as a CPU 1006, a GPU 1008, and a GPU 1010. CPU 1006 can be coupled to GPU 1008 via a die-to-die (D2D) or chip-to-chip (C2C) interconnect 1012, such as a Ground-Referenced Signaling interconnect (GRS interconnect). CPU 1006 can be coupled to GPU 1010 via a D2D or C2C interconnect 1014. CPU 1006 can also couple to GPU 1008 and GPU 1010 via PCIe interconnects.

CPU 1006 can be coupled to one or more NICs or DPUs, which are coupled to one or more networks. For example, as illustrated in FIG. 3, CPU 1006 is coupled to a first NIC/DPU 1026, which is coupled to a network 1030. CPU 1006 is also coupled to a second NIC/DPU 1028, which is coupled to network 1030. NIC/DPU 1026 and NIC/DPU 1028 can be coupled to network 1030 over Ethernet (ETH), NVLINK or InfiniBand (IB) connections, for example.

Computing system 1000 also includes a processing device 1004 with a multi-GPU architecture. In particular, processing device 1004 includes multiple subsystems including a CPU 1016, a GPU 1018, and a GPU 1020. CPU 1016 can be coupled to GPU 1018 via an D2D or C2C interconnect 1022. CPU 1016 can be coupled to GPU 1020 via a D2D or C2C interconnect 1024. CPU 1016 can also couple to GPU 1018 and GPU 1020 via PCIe interconnects. CPU 1016 can be coupled to one or more NICs or DPUs, which are coupled to one or more networks. For example, as illustrated in FIG. 3, CPU 1016 is coupled to a first NIC/DPU 1032, which is coupled to a network 1036. CPU 1016 is also coupled to a second NIC/DPU 1034, which is coupled to network 1036. NIC/DPU 1032 and NIC/DPU 1034 can be coupled to network 1036 over Ethernet (ETH), NVLINK or InfiniBand (IB) connections.

In at least one embodiment, processing device 1002 and processing device 1004 can communication with each other via a NIC/DPU 1038, such as over PCIe interconnects. Processing device 1002 and processing device 1004 can also communicate with each other over a high-bandwidth communication interconnects 1040, such as an NVLink interconnect or other high-speed interconnects.

In various embodiments, system 1000 and/or any of its components, e.g., the entire system, superchips, NICs/DPUs, and/or individual CPUs or GPUs, may employ the disclosed techniques for allocation of electrical power quotas based on packet processing performance.

Although the embodiments described herein mainly address power management in computing and communication systems such as data centers and HPC clusters, the methods and systems described herein can also be used in other applications, such as in large-scale simulators and “big-data” processing systems.

Thus, more generally, a power management controller may comprise an interface and a processor. The interface is operationally coupled to multiple subsystems that process data. The processor may obtain one or more performance degradation metrics, which indicate degradations in performance of the subsystems in processing the data, evaluate a cost function defined over the performance degradation metrics, and allocate respective electrical power quotas to the subsystems, aiming to minimize the cost function.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A packet processing and communication system, comprising:
multiple subsystems, to process and communicate packets; and
a power management controller, to:
obtain one or more performance degradation metrics, which indicate degradations in performance of the subsystems in processing the packets;
evaluate a cost function defined over the performance degradation metrics; and
allocate respective electrical power quotas to the subsystems, aiming to minimize the cost function.

2. The system according to claim 1, wherein:
the system further comprises one or more Power Management (PM) circuits to limit power consumption of at least one of the subsystems; and
the power management controller is to allocate the electrical power quotas by controlling the PM circuits.

3. The system according to claim 2, wherein at least one of the PM circuits comprises a current limiter circuit to limit input current to a corresponding subsystem.

4. The system according to claim 2, wherein at least one of the PM circuits comprises a voltage/frequency control circuit to set one or both of (i) an operating voltage and (ii) a clock speed, of a corresponding subsystem.

5. The system according to claim 1, wherein at least one of the performance degradation metrics is indicative of a rate of packet dropping by one or more of the subsystems.

6. The system according to claim 1, wherein at least one of the performance degradation metrics is indicative of a number of pending packets in one or more of the subsystems.

7. The system according to claim 1, wherein at least one of the performance degradation metrics is indicative of a latency in processing the packets in one or more of the subsystems.

8. The system according to claim 1, wherein at least one of the performance degradation metrics is indicative of an extent of backpressure, which throttles reception of packets in one or more of the subsystems from one or more other subsystems.

9. The system according to claim 1, wherein at least one of the performance degradation metrics is indicative of an extent of flow control, which throttles transmission of packets from one or more of the subsystems to one or more other subsystems.

10. The system according to claim 1, wherein the power management controller is to run an iterative process that obtains updated values of the performance degradation, re-evaluates the cost function over the updated values, and reallocates the electrical power quotas based on the re-evaluated cost function.

11. The system according to claim 1, wherein the power management controller is to enforce the allocated electrical power quotas on the subsystems only when the communication system as a whole exceeds a specified power consumption.

12. The system according to claim 1, wherein the power management controller is to modify the cost function in response to a hint indicative of a pattern of packet processing or communication in the system.

13. The system according to claim 1, wherein the power management controller is to modify the cost function in response to a hint indicative of a type of application running in the system.

14. The system according to claim 1, wherein the power management controller is to modify the cost function in response to a hint indicative of a ratio between east-west traffic and north-south traffic in the system.

15. The system according to claim 1, wherein the power management controller is to evaluate the cost function by calculating a weighted sum of two or more of the performance degradation metrics.

16. A power management method, comprising:
processing and communicating packets by multiple subsystems of a system;
obtaining one or more performance degradation metrics, which indicate degradations in performance of the subsystems in processing the packets;
evaluating a cost function defined over the performance degradation metrics; and
allocating respective electrical power quotas to the subsystems, aiming to minimize the cost function.

17. The method according to claim 16, wherein at least one of the performance degradation metrics is indicative of a rate of packet dropping by one or more of the subsystems.

18. The method according to claim 16, wherein at least one of the performance degradation metrics is indicative of a number of pending packets in one or more of the subsystems.

19. The method according to claim 16, wherein at least one of the performance degradation metrics is indicative of a latency in processing the packets in one or more of the subsystems.

20. The method according to claim 16, wherein at least one of the performance degradation metrics is indicative of:
an extent of backpressure, which throttles reception of packets in one or more of the subsystems from one or more other subsystems; or
an extent of flow control, which throttles transmission of packets from one or more of the subsystems to one or more other subsystems.

21. A power management controller, comprising:
an interface, to operationally couple to multiple subsystems that process and communicate packets; and
a processor, to:
obtain one or more performance degradation metrics, which indicate degradations in performance of the subsystems in processing the packets;
evaluate a cost function defined over the performance degradation metrics; and
allocate respective electrical power quotas to the subsystems, aiming to minimize the cost function.

22. A power management controller, comprising:
an interface, to operationally couple to multiple subsystems that process data; and
a processor, to:
obtain one or more performance degradation metrics, which indicate degradations in performance of the subsystems in processing the data;
evaluate a cost function defined over the performance degradation metrics; and
allocate respective electrical power quotas to the subsystems, aiming to minimize the cost function.
